(19) United States
(12) Patent Application Publication
(10) Pub. No.: US 2020/0047049 A1
(43) Pub. Date: Feb. 13, 2020

(54) METHOD AND APPARATUS FOR PLAYING GAMES

(71) Applicant: Boktiar Ahmed, Essex (GB)

(72) Inventor: Boktiar Ahmed, Essex (GB)

(21) Appl. No.: 16/607,280

(22) PCT Filed: May 21, 2018
(86) PCT No.: PCT/GB2018/051356

§ 371 Date: Oct. 22, 2019

(30) Foreign Application Priority Data
May 21, 2017 (GB) 1708135.7

(51) Int. Cl. A63B 69/00; A63B 63/00; G09B 19/00; A63B 5/22; A63B 24/00; A63C 19/06

(52) U.S. Cl. CPC A63B 69/0053; A63B 63/00; G09B 19/0038; A63B 43/004; A63B 24/0075; A63C 19/062; A63B 5/22

(57) ABSTRACT

The apparatus has a playing background of a collection of electronic markers or, a playing background of a collection of electronic markers, and one or more motional elements which are also able to process electrical signals. The method of using the apparatus includes generating several observable signals during a period of time, each representing an instruction to the player for the motion of the one or more motional elements of the game through the playing background in various combinations, chosen from passing a marker on a particular side, with a distinct observable signal for each possible side to pass a marker by or a subset thereof containing at least two members; or moving in the direction from near the current marker to a neighbouring one, with a distinct observable signal for each possible direction or a subset thereof containing at least two members; or moving through the line segment or region defined by a group of adjacent markers; or, in the case where the height level of the markers vary, moving from one part of the playing background to another; or, in the case of a playing background consisting of several, separate lines each split into smaller segments, travelling over a particular segment; or, in the case of a playing background consisting of a surface that is fully covered by a collection of non-overlapping markers, moving from one marker to another. The observable signals will appear on either one or both of one or more of the markers; or, one or more of the motional elements. All signals will be generated automatically by one or more of the markers; or, by one or more of the motional elements; or, by one or more separate devices; or, by some combination thereof; and such signals will collectively define an observable path through the playing background.

The present specification relates to a method and apparatus for playing games, particularly but not exclusively physical games.

The element of running and evading opponents is a key part of many sports, including association football, rugby, basketball, American football, field and ice hockey. In some cases the difficult part also includes having to carry the ball or similar object at the same time, e.g. association football, whilst in other cases the object carrying is relatively simple.

Players often train for this part of their game by using an arrangement of markers or similar objects and navigating through them. This is an extremely useful form of training and in particular helps develop their ball carrying skills. However, it lacks the crucial element of taking on opponents in real games in which the player will have to make very quick decisions to evade them at the same time as carrying the ball with them.

The object of the present invention is to introduce unpredictable elements into a training exercise or even actual play to develop or test a player's skill and capabilities.

According to the present invention, there is provided a game playing system consisting of a physical apparatus and a method utilising electrical signals as provided by claim 1. According to another aspect of the present invention, there is provided a motional element as provided by claim 5. According to another aspect of the present invention, there is provided an apparatus as provided by claim 7.

As used in the description and claims, the term “marker” is used to mean a physical object used to define a position in space.

The term “electronic marker” is used to mean a marker which is also able to process electrical signals.

The term “playing background” is used to mean an arrangement of markers over a region of space which can be used for sports training or playing games.

The term “endzone” is used to mean a specially designated group of markers within a playing background which constitute its beginning or its end. When this concept is used, there will usually be a pair of endzones.

The term “motional element” is used to mean a moving part of a sport or game. When the player has to move as part of the game then the player is an example of a motional element. Anything that accompanies the player, such as a ball, an animal or vehicle, is also a motional element. The player is not a motional element when not moving in which case the object being controlled by the player is the motional element, such as a remote controlled toy car. If there is more than a single motional element they will usually travel together (e.g. player and ball). However, an act such as the player shooting a ball towards a goal will cause a separation, after which event attention will usually be restricted to one of the motional elements which for this particular example will be the ball.

The terms “apparatus” and “system” will sometimes be used interchangeably, especially in the context of signal processing. When something is referred to as being part of the system it means that it is involved in the signalling process. If the player is referred to as being part of the signalling process then it implicitly means a device will be fitted onto the player to enable such signalling.

The term “signal indicator” is used to mean an observable signal, such as light being turned on or made to flash, a piece of audio, a form of mechanical movement or even a magnetic obstruction and represents an instruction for the to motion of the motional elements through the playing background or defines a target for the passing or shooting of a motional element or specifies some method of completing an instruction such as carrying the ball using one particular feet. It can be produced on the markers, on motional elements or on a separate audio visual device. The “signal state” is synonymous with the signal and may in particular be used to understand the information encoded in a signal.

An appropriate collection of signal indicators over a period of time will define a path through the playing background. Such a path will be a random path when the signals are random and in particular will not be known to the user in advance. In special cases, a random path reveals to the player a unique path of travel from one endzone to another from amongst all possible paths. When the system includes passing or shooting instructions, a random path will end when such an instruction is executed, which will define the final part of the travel path of the ball or a similar object. A method of playing signal indicator, for example one which instructs the player to carry the ball using one particular feet, does not affect the geometric path followed by the motional element and is not considered part of a random path.

The term “playing session” is used to mean the period of time from the apparatus being turned on to when it is turned off and during which the apparatus will simulate many paths.

The invention is that of a system which is able to generate observable travelling paths through an arrangement of markers for the purpose of sports to training and games playing. Players or objects controlled by players will be required to traverse the generated path, without knowing in advance, in the random case, what the path will be.

The random element can be introduced by replacing the simple markers by an electronic system which will be able to instruct the player at very short notices to travel in a particular direction through the markers, seemingly in an unpredictable manner. The introduction of randomness will force the player to make quick motional decisions and hence provides a simulation of playing against real opponents. The same solution can of course also generate predictable paths.

The use of random instruction training can be naturally extended to cover passing and shooting. A signal to a random target will train players, for example, to quickly make decisions on which part of the goal to shoot at.

The invention can also be used to take part in other activities in new ways by introducing an element of mental decision making which will enhance the experience, e.g. skiing, go-karting, ice skating, roller blading, quad biking, jet skiing, remote controlled toy car driving, etc. Generally, any activity which involves completing a course can include a system which changes the course in a random way.

By default, the playing background of the markers is a part of the system/apparatus. If a motional element is involved in the signalling process, it to is also a part of the system. The system will also usually include a controller which generates and transmits signals to other parts of the system. In some cases the system may also include a separate display unit and in other cases elements of a positioning system will also be a part of the apparatus. Additional features such as sensors on the markers can be included to improve the functionality of the apparatus.

The invention will now be described, by way of example, with reference to the drawings, of which;

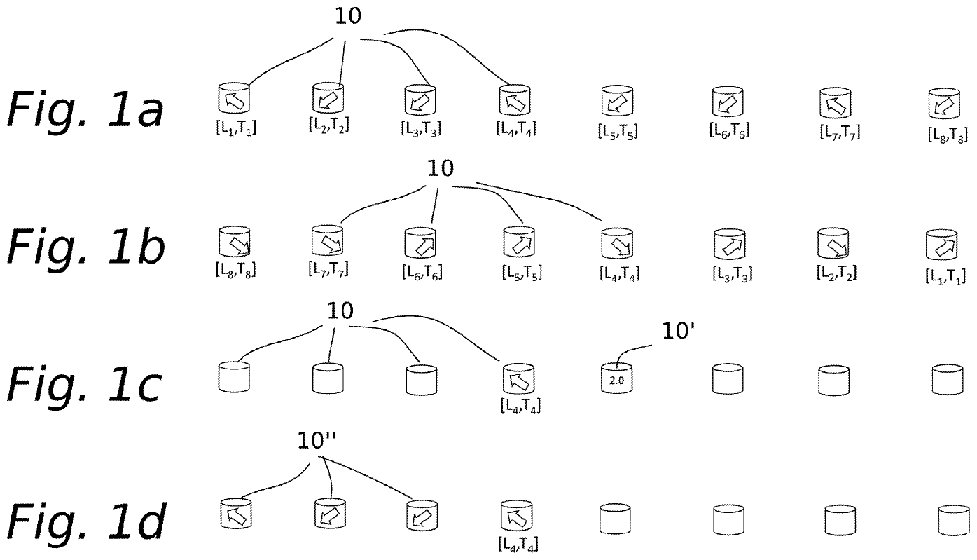

FIG. 1 shows examples of simulated random paths in a one-dimensional, linear embodiment of the markers;

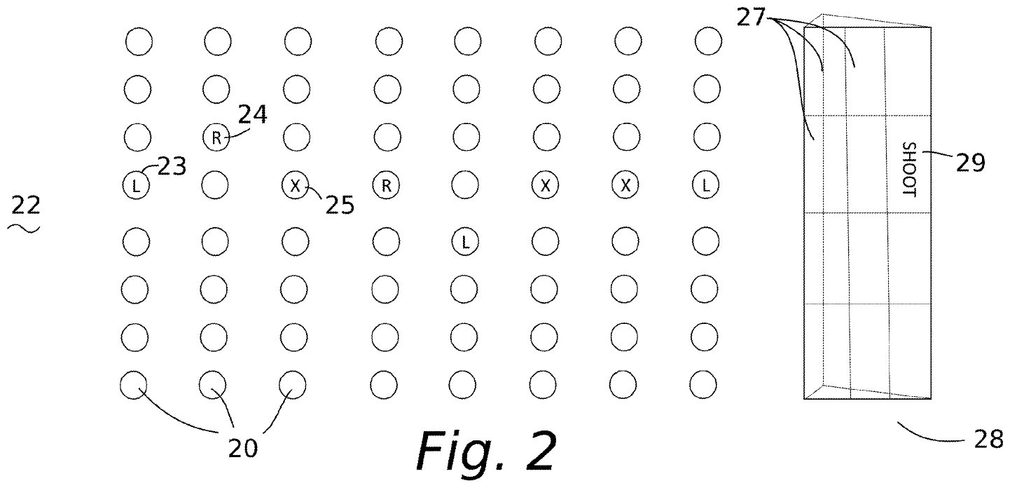

FIG. 2 shows example of a simulated random path, incorporating a third signal X to travel straight, in a two-dimensional planar embodiment of the markers including instruction to shoot into a particular part of the goal area;

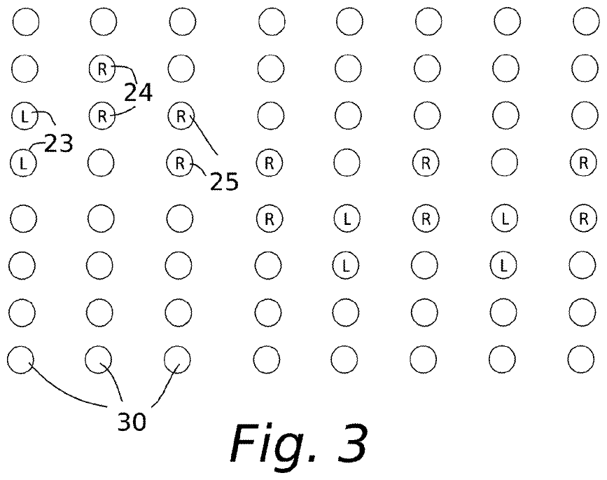

FIG. 3 shows example of a simulated random path in a two-dimensional planar embodiment of the markers with markers signalling in pairs;

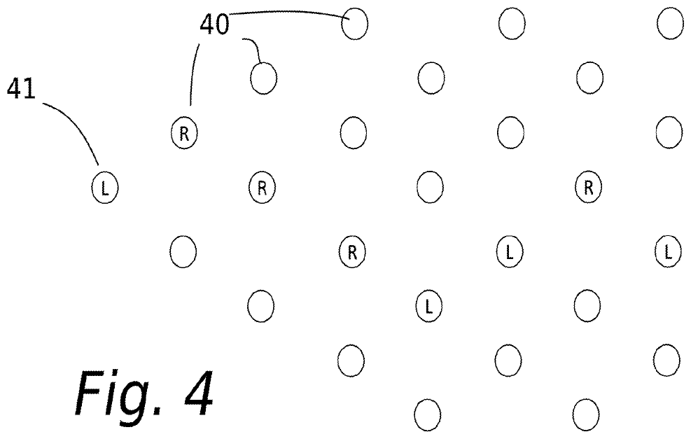

FIG. 4 shows a two-dimensional embodiment of the markers with some efficiency savings;

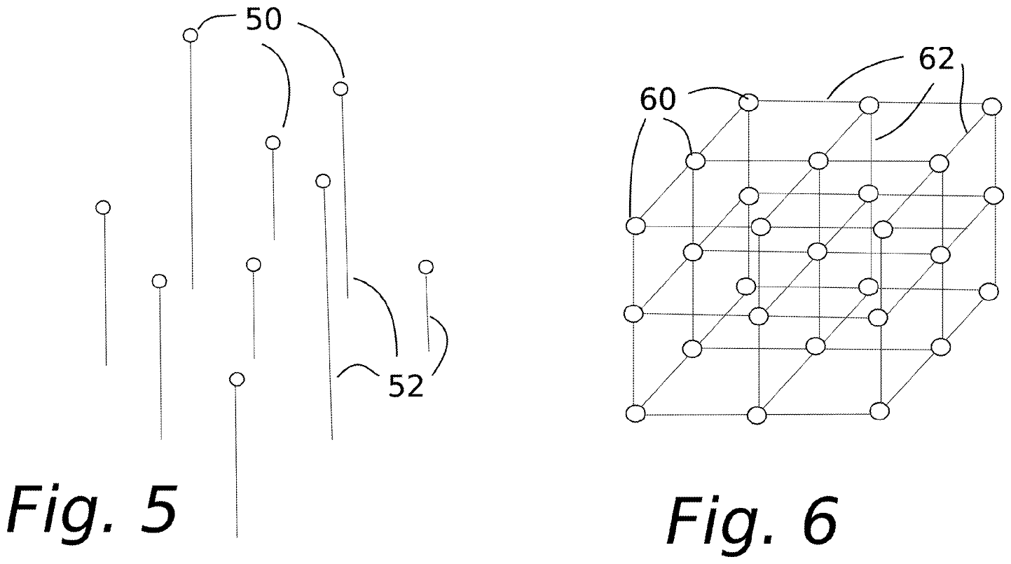

FIG. 5 shows an example of a two-dimensional curved surface embodiment of the markers;

FIG. 6: shows an example of a three-dimensional embodiment of the markers;

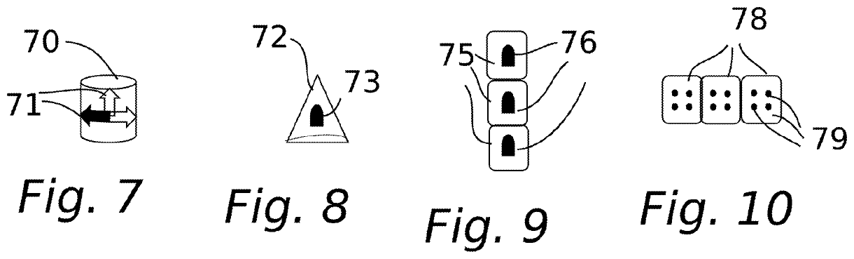

FIGS. 7-15: show some examples of electronic markers;

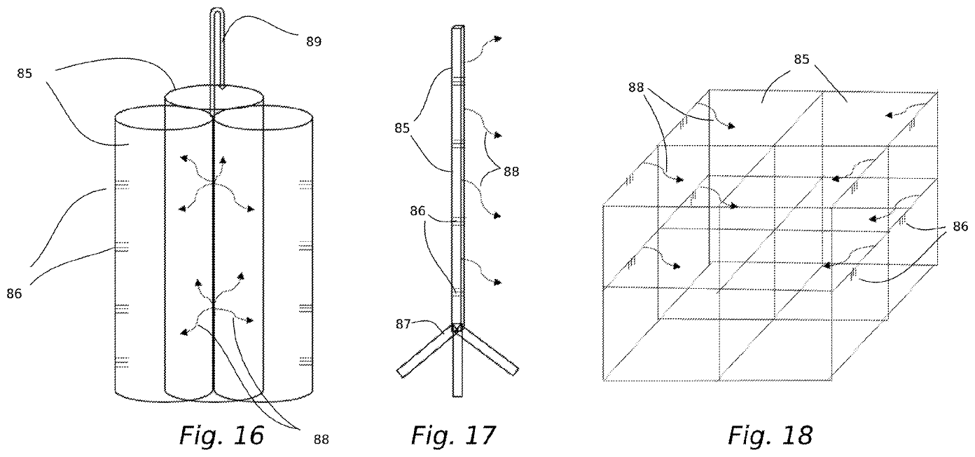

FIGS. 16-18: show some examples of storage apparatuses for electronic markers;

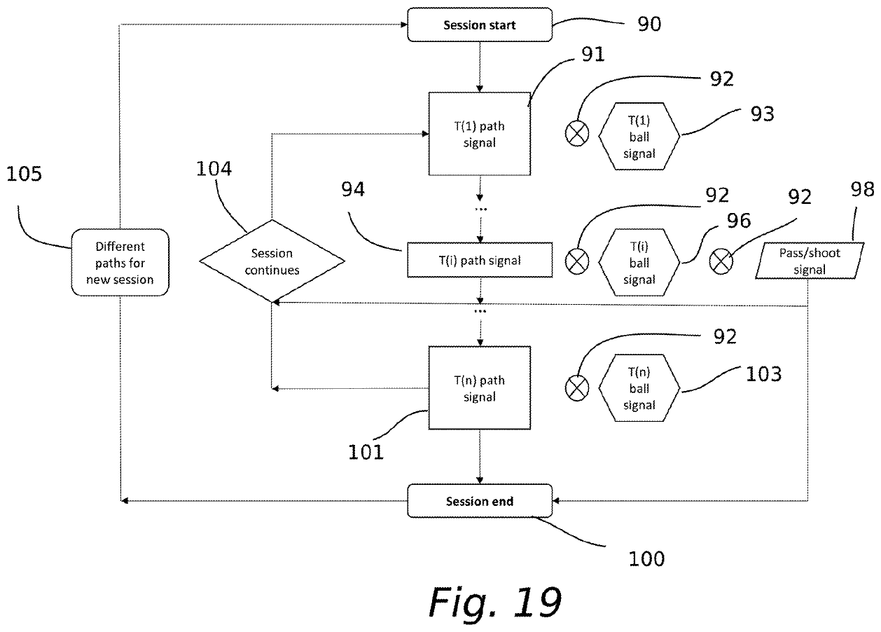

FIG. 19 is a flow diagram of how random paths will be simulated.

Referring to FIG. 1, a simple game apparatus comprises a row of markers 10 which are arranged in a straight line. The markers and associated signals have here been labelled LₙTₘ (strictly, [Lₙ, Tₘ] in the figure), where Lₙ indicates a location n, and Tₘ indicates a time m at which a signal was revealed by Lₙ. Each marker 10 includes a display means which can display an arrow in two orientations, which represents an instruction to a player to pass the marker in one of two directions (on the left or on the right). The system will draw a random number to determine the direction which will not be known in advance to the player.

FIG. 1a shows a row where the leftmost marker L₁T₁ is activated first to indicate a direction to the player. The markers L₂T₂ to L₈T₈ are then activated in a sequence travelling from left to right, with the orientation arrows being displayed in one of the two possible orientations in an unpredictable or random manner. The player has to pass each marker in turn in the direction indicated. Since the player cannot learn or prepare for which orientation will be displayed, their reaction time and flexibility is increased by using this apparatus.

FIG. 1b shows the sequence in which the markers are activated being reversed, so that the rightmost marker L₁T₁ is activated first, and the markers L₂T₂ to L₈T₈ are then activated in a sequence travelling from right to left.

It may be useful to indicate the time allowed or remaining to reach the next to marker, for example by a signal on that marker or by a display on a separate device, such as on a controller or on a device dedicated for this purpose. FIG. 1c shows the observable signals for the simulated path of FIG. 1a at time T₄ under one possible embodiment, showing the direction to travel at L₄T₄ and the time allowed to reach the following marker 10′.

Preceding signals may either disappear or stay on so that the participant can view the complete path afterwards. FIG. 1d shows marker L₄T₄ being activated, while orientation displays of previously activated markers 10″ persist.

The markers need not be uniformly spaced nor do the time intervals between the successive signals have to be the same; indeed they can even be stochastic. The system may allow the user to configure it so that the time intervals can be either deterministic or stochastic. In the former case, it may allow the user to specify each time interval separately. In particular, the time intervals can be uniform but varied from one training session to another to increase or decrease the tempo of training. In the case of stochastic time intervals, the system may be configured to allow the user to specify the distribution of the various time intervals. The number of markers used can of course be increased or decreased.

It could be advantageous for simulations to alternatively start on the left and then on the right so that the participant can continue practicing running through the markers without having to return to the original starting point. There will be an appropriate time interval between consecutive simulations. The system may include a user interface to allow the participant to specify these and to various other configuration parameters.

Some embodiments may include sensors on the markers to track the actual path traversed by the motional elements. This actual travelled path can be displayed by the markers and may also be sent to separate processing units. Alternatively, a positioning system can be used to track the movement of the motional elements.

The embodiment in this figure is one-dimensional and linear. Non-linear one-dimensional embodiments, particularly closed circuits, can be useful for various pursuits. A remote controlled toy car, as a particular example, can be driven around a closed circuit. It will have to pass each marker on the indicated side. Because it is a closed loop, the circuit will begin and end on any one designated marker. Generally, a one-dimensional embodiment with signalling by one marker can only produce an instruction to pass a marker on either its left or right side.

It would be useful for some applications to allow successive signals to appear on non-adjacent markers, subject to allowing an appropriate duration of time for the motional elements to reach the following marker, as mentioned later in greater generality. In such cases, however, the system will no longer specify a unique travel path by its signalling as the player can decide to travel on either side of any intermediate markers.

It is also possible to indicate an instruction by using signals on two adjacent markers. Such a signal would represent the instruction to travel between the to markers from one side to another within a specified time period. Successive signals may appear on adjacent marker pairs anywhere within the playing background.

Higher dimensional embodiments of the invention will be discussed in the following sections. At this stage it may be mentioned that it is possible for there to be embodiments that are not fully 1- or 2-dimensional. For example, there may be a line of markers at the last one of which will begin two separate lines of markers in the shape of the letter Y. The three line segments are each 1-dimensional, but the intersection point is not as it has two markers following it. Similar remarks apply to closed loop embodiments.

Many of the remarks, such as on time dynamics, apply equally to other embodiments of the system in an obvious way and will often by omitted for brevity.

Referring to FIG. 2, markers 20 are arranged in a two-dimensional planar array, which is particularly suitable for a player practising with a football (though of course it could be used or adapted for other sports). A player starts the exercise at the leftmost side 22 with a football. A neighbouring marker 20 from each row activates sequentially; in this example, marker 23 activates to display ‘L’, indicating that the player should pass to the left of the marker when proceeding from the bottom row (one endzone) to the top row (other endzone) with the football. Next, the marker 24, which the player would have reached by observing the instruction on marker 23 at the previous time to instance, displays ‘R’ to indicate that the player should pass to the right of that marker, and then the marker 25 displays ‘X’ to indicate the player should proceed straight ahead. This continues until the player has passed all the markers and stands in front of an array of targets 28. When the player reaches this endzone, or just before, a target 29 activates, indicating to the player that they should shoot the ball at the target. The goal area shown has been split into smaller cells and this split varies horizontally and vertically. To indicate that a particular cell is the target, light could, for example, be made to come on around its perimeter or just on the four corner points. It will also be meaningful for the goal area to only vary horizontally, in which case each target cell will be a short line segment and can be easily constructed by placing discrete markers at the two end points.

Goals may be added to both sides of the playing background to enable continuous practice, although the waiting time between consecutive simulations may need to be increased in this case as the player will need to retrieve the ball after shooting. Furthermore, the system can allow some markers to have a dual purpose; they can either be used to define positions to travel pass or be used as part of the goal (e.g. for a 1-dimensional system with 12 markers, up to 4 may be removed to be used as goal markers).

Instead of interpreting signals on goal cells as target, it would be meaningful to interpret the same signal as representing the area occupied by the goalkeeper, so in that case the instruction to the player becomes to shoot into another part of the goal. Generally, the system can signal into multiple cells and these signals can either represent targets for shooting into the goal or to avoid (i.e. to shooting into the complementary area).

It would be possible to configure the system to signal shooting instructions into, for example, the left and right edges of the goal, as typically a goalkeeper will be positioned in the middle of the goal. Of course this can be taken to its logical extreme, where the target is known in advance i.e. the deterministic case. Alternatively, the goal area can be one single piece without being split into smaller regions.

Shooting instruction may, in general, be given at any time and the target can change over the course of play.

When the goal is constructed from markers, it will be possible to specify the target cell by a signal on one marker only. For example, when the goal area consists of a row of several markers, a signal on one marker will indicate that the target cell is the area between that marker and the one to its right (obviously, there will be no signal to the right most marker with this interpretation). A similar approach works when the goal varies both horizontally and vertically, with a target goal cell indicated by a signal on, for example, its bottom left marker.

Additional markers may be added to the ones depicted in this figure to represent locations to one of which the player may be instructed to pass the ball in a random manner.

As for the first embodiment described, the marker spacing may be varied and to need not be regular. The timing between signals can be also be varied, either in a regular manner, or a random manner, in a similar way as was described for the first embodiment. Furthermore, this particular embodiment can also be used without the array of targets 28.

The markers 20 are here shown with the displays being persistent after activation; however, it will be appreciated that, as in the previously described embodiment, each display could be deactivated when the subsequent marker is activated, or after a set time. The instructions displayed by each marker (that is, ‘L’, ‘R’ and ‘X’ for ‘left’, ‘right’ and ‘straight ahead’ respectively) are unpredictable to the player and will be randomly determined. The marker in the first row may be determined randomly, or could be assigned by the user. The marker to be activated in a subsequent row is then determined from the marker activated in the previous row and the instruction it displayed. The instructions displayed by the markers at the left and right edges of the array, from the player's perspective, will be limited so as to keep the path within the array.

The instruction ‘X’ for going straight ahead is ambiguous because it doesn't specify whether the player should pass the current marker on the left or on the right. For the other two cases, ‘L’ and ‘R’, there is a natural side to pass the current marker when going to the specified destination marker (i.e. ‘L’ naturally means pass current marker on the left then go to next marker on the immediate left, etc). To resolve the ambiguity, the precise meaning of the signals must be clarified.
1. Signals specify destination marker for next time instance: the player may pass the current marker on either side; ambiguity remains.
2. Signals specify side to pass current marker at current time instance: the system will signal ‘L’ or ‘R’ only, with the player then going to the left or right marker, respectively; instruction ‘X’ will not appear and there will be no ambiguity.
3. Signals specify side to pass current marker at current time instance and destination marker for next time instance: for example, passing current marker on the right to go to the next marker on the left is one possible instruction under this interpretation. The system will of course need a distinct observable signal for each instruction.

Any one of the three interpretations above can be implemented, although perhaps the most natural would be a restricted version of the third under which a maximum of four instructions {‘L’, ‘R’, ‘X1’, ‘X2’ } are possible, with ‘L’ meaning passing current marker on the left to reach next marker on the left with a similar meaning for ‘R’, and ‘X1’ meaning go straight by passing current marker on the left and “X2” the same but passing current marker on the right. This would require the system to be able to reveal four different signals.

The above discussion also applies to 3-dimensional embodiments.

FIG. 2 illustrates a player progressing forward towards the goal every time instance. This is the most ideal form of play; however, in real life a player may also be forced to travel sideways or backwards. Instructions for both of these types of motion through a collection of electronic markers can also easily be to incorporated into the invention.

Referring to FIG. 3, the markers 30 in the two-dimensional planar array may signal in pairs 23, 24, 25, indicating travel between each pair of markers. Each member of the pair will signal the same direction for travelling. Alternatively, the following pair through which the motional elements must travel may signal at the same time as or just after the current pair to clearly communicate the direction of motion.

Referring to FIG. 4, a possible efficiency gain in the design may be made. Under the arrangement, the player starts at a single marker 41, and the size of the array of markers 40 then increases from bottom to top (in this particular arrangement, until a maximum width is achieved). There are fewer markers initially and when the instructions are only “left” or “right” some of the markers can also be removed to leave a diamond lattice formation as shown.

The calculation and activation of the signal display of the markers is typically directed by a controller. Under a rectangular arrangement, it may be easier for the system to generate paths for multiple players at more or less the same time, possibly by using more than one controller. If a single controller is used, in between consecutive signals for one player, signals to markers for each of the other players will have to be sent.

The arrangements described in respective of FIGS. 2 to 4 are planar because all markers are at the same height above the ground or water surface; however to a three dimensionally distributed array is also possible.

Referring to FIG. 5, the markers 50 may be located on poles 52 of different heights arranged over a surface (which may or may not be flat), thus providing a two-dimensional non-planar playing background. Alternatively, the poles may be fixed to a ceiling so that the markers are suspended at different levels. Poles of same height above a water surface may be used to create a playing background for various water based activities.

The two-dimensional planar and non-planar playing backgrounds are the two-dimensional equivalent of one-dimensional linear and non-linear playing backgrounds. Another type of a one-dimensional embodiment is that of a closed loop or circuit. A two-dimensional version of such an embodiment would be loops enclosed within larger successive loops, similar to running and velodrome cycling tracks, with a particularly simple version being concentric circles. Such an embodiment could be used as successive tracks for a remote controlled toy car to travel through, for example, starting with the innermost loop. Alternatively, simultaneous signals can be sent to multiple loops each one for a separate toy car or any other appropriate object. Another alternative application would be to signal to adjacent markers to instruct the motion of a remote controlled toy car through them in a similar manner to what was depicted in FIG. 3.

Referring to FIG. 6, markers 60 may be suspended by posts, lines or cabling 62 in a three-dimensional playing background; this shows a regular rectilinear lattice, though an irregular lattice could also be provided. Such arrangements to are suitable for creating games for objects that can fly, in particular such objects whose flight is remotely controlled by a player. A three-dimensional arrangement under water is of course possible.

FIGS. 7 to 15 show some examples of objects of different geometrical shapes that may be used as markers. In different applications they may be placed on a natural earth surface, a man made surface, indoors or outdoors, in water, on ceilings, on the walls of buildings, embedded within or on the surface (e.g. racing track for remote controlled toy cars), and in various other environments. They may have special features to ensure that they are not easily moved from where they are placed, such as fittings or adhesives, and be built to withstand possible collisions with the motional elements of a game. Additional features to ensure any signals that they produce remain visible under different weather conditions may also be included. The markers may also cover the whole surface rather than discrete points on it, with the surface split into small cells. A system of illuminable lines may also be used.

Electrical markers may require their own power supply and which may be provided in any currently known manner, such as battery cells, rechargeable battery cells, solar cells; in other cases they may be connected to a power network. Alternatively, the markers, and potentially the motional elements of the system, may extract the required power from the wireless signals. Electrical markers may have charging and other known ports for purposes such as docking into a device. They will include the necessary circuits to perform various tasks required by the system such as receiving electrical signals, producing an electrical signal, generating an observable signal such as lighting, to performing calculations and detecting other objects or motion. As well as lighting for signalling, the markers may also have additional lighting for playing during the evening or in a cloudy environment.

For some applications, the benefit of using the system may be enhanced by enabling the markers to move. When, for example, the signal indicates travelling on the left, this instruction may be strengthened by the marker moving slightly to the right, thereby obstructing motion in that direction just like a real opponent. The marker would then return to its original position shortly after the signal was sent.

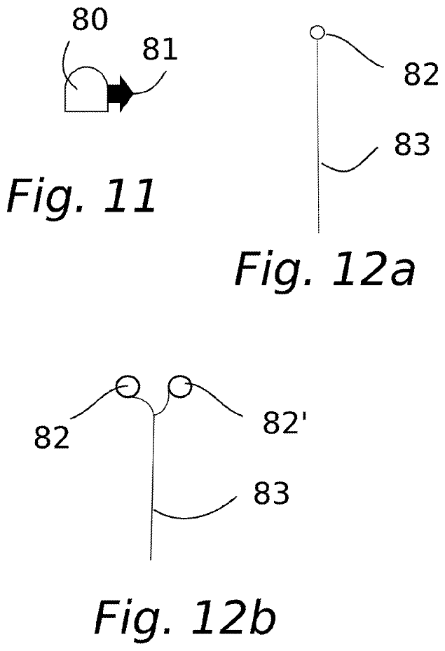

The markers will typically be required by the system to convert electrical signals into a form observable by the player. Referring to FIG. 7, the marker 70 may comprise different illuminable arrow shapes 71, such that a particular control signal causes one of the arrows to light to indicate a particular direction. Referring to FIG. 8, the marker may include only a single light bulb which can be illuminated in as many colours as there are directions of motion, so that each colour corresponds to a different direction. FIG. 9 shows a marker where several marker units 75 are stacked, with a signal being revealed by only one of the units being illuminated representing motion in a particular direction. It would easily be possible to introduce a ‘pause’ signal instructing the player to remain stationary at the marker for a short while by, for example, the illumination of more than one unit of the stack; this can also be done for many other types of markers. Similarly, LEDs 79 may be grouped on different parts of the marker 78 surface, such as in FIG. 10, with a signal being revealed by only one of the groups being illuminated, or made to flash, to representing a direction of motion. Light flashing may be used for other types of markers to improve signal visibility. Light signals may emanate from inside a transparent marker or from the marker surface. The signals may also manifest themselves by a mechanical or magnetic obstruction appearing on the side not to travel on, such as shown in FIG. 11, where the arrow 81 represents an arm extended from a marker body 80. As previously mentioned, the marker may comprise a light or similar signal 82 located on a pole 83 as shown in FIG. 12a, with FIG. 12b showing a simple extension using two light bulbs on the pole, which of course can be generalised by adding even more light bulbs.

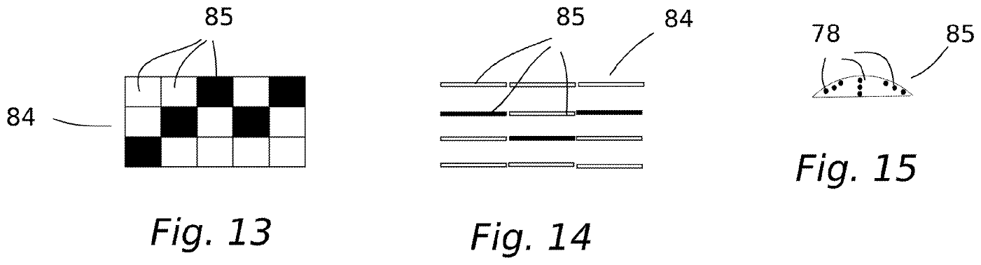

FIG. 13 shows a two-dimensional region 84 being precisely covered by discrete, smaller area element markers 85 for which the random travel path is indicated by the successive shaded area elements. FIG. 14 shows small line segment markers 85 over a two-dimensional surface 84 with the random travel path indicated by the shaded lines. Signals on the shaded area or line elements may be in the form of lighting and last for a brief time period during which the motional elements will be required to be in or move across the shaded elements. This should be contrasted with earlier examples in which the motion avoided any contact with the markers, possible because there was space between the markers.

FIG. 15 is a hemispherical marker 85 with groups of LEDs 78 on its left, middle and right. A signal will be revealed by one group of LEDs being illuminated or made to flash to indicate the corresponding direction of motion. If only left and right directions of travel are allowed then the middle group of LEDs will not be necessary. Even when there is a third type of motion such as to travelling straight ahead, the middle group of LEDs can be avoided by, for example, simultaneously signalling with the left and right groups of LEDs to represent this instruction.

For some embodiments observable signals may appear on motional elements, in addition to or instead of on the markers. In such cases the motional elements will have the appropriate features to enable this, similar to what has been described above.

Electronic markers will be more expensive than non-electronic or ‘dumb’ markers. Using them for some sports training could be a concern given risk of damaging them. This concern can be alleviated by making them sturdy enough to withstanding contact with players or other motional elements. Alternatively, electronic markers can be used just for signalling alongside ‘dumb’ markers around which training takes place. This type of use of the system will be somewhat unnatural as in real life the player will focus on the one opponent directly facing them and quickly decide at that instant which way to go past them; the opponent will be one single body rather than a pair. It will also be very cumbersome in 2-dimensional cases.

Electronic markers may also be used by attaching them to ‘dumb’ markers, e.g. on top of traditional training cones. This will reduce the risk of damage to expensive parts whilst still preserving a single marker body.

Referring to FIGS. 16 to 18, there are shown some examples of apparatuses for the storage of electronic markers 85.

A suitable topology for such an apparatus will depend on the topology of the markers being stored. The first two examples are of a group of cylinders on a common support 89 and a simple upright stick with ground support 87. Markers will be stored in these apparatuses by being stacked on top of each other. The third example is of a cube with separate storage cells for each marker 85. All three examples include one or more charging ports, represented by charging leads 88 or alternatively charging sockets 86.

### Preferred Embodiment

The preferred embodiment is for a controller to generate and transmit the signals and for the markers to receive and reveal them to the player. Signals may additionally be sent to motional elements to specify a particular method of playing.

The solution under the preferred embodiment has the following key elements both of which are performed by the controller:

Generation of Random Paths

Transmission of the Signals

Each of these elements will now be covered in detail.

Generation of the Random Paths

Under the preferred embodiment, a random path is specified by a sequence of increasing time instances, the addresses of the elements of the system indicating a signal at each one of these time instances and their data content. The data content at each time instance is restricted to one of finitely many to possible values, each resulting in a particular signal indicator with the outcome determined by the drawing of random numbers. Starting from the markers signalling at the current time instance, the drawing of the random numbers at that time instance determines, in general, the markers which will be signalling at the following time instance. Because there are only finitely many possible data values at each time instance, drawing from very simple probability distributions is required. As stated previously, the markers signalling at the initial time instance of a random path can be assigned by the player or be determined by the controller by drawing from a separate probability distribution.

As mentioned previously, one or two adjacent markers can be used to indicate a signal for one-dimensional embodiments. Adjacent in this context means that there are no non-signalling markers in between the signalling ones at a given instance in time.

For the two-dimensional case, signal indication using one or two adjacent markers have already been described. As a natural extension, signalling by four adjacent markers forming a rectangle (or topological equivalent) may also be permitted. In the three-dimensional case, signals may be indicated by one single marker, two adjacent markers, four adjacent markers and eight adjacent markers (forming a cuboid or similar eight-cornered space).

Using such regular grouping of markers means that knowing the location of one specified marker within the group, which will be referred to as the primary marker for the group, determines the location of all the remaining ones, the non-primary markers, within the playing background. This is true at every time instance of a random path. It would, of course, be possible to simultaneously signal to other groups of markers, e.g. triplets or quintuplets etc, instructing motion through the regions defined by the signalling markers.

Simultaneous signals to multiple markers may be achieved by including multiple decoders within each marker. For example, when signalling is in pairs of markers as in FIG. 3, each marker may have two decoders, one of which will be identical to a decoder on the marker to its left and the other identical to a decoder on the marker to its right. The correct signal will then activate a given pair of markers. Alternatively, it may be acceptable to signal each marker within the group successively (with possibly successively shorter delays in the processing of the signals by the markers to best achieve simultaneity).

Referring to FIG. 19, which provides a high level illustration of the simulation process, between the start of the playing session 90 and its end 100, there will be many simulated random paths. A random path under the preferred embodiment is characterised by observable signals at times T(1), . . . T(n) (note that for improved legibility, the symbol T(1) etc. is used for time instances instead of T₁ etc.). For simplicity, the time index is reset to 1 at the start of each new path.

At time T(1), for instance, the path signal 91 will be a signal indicator on a group of adjacent markers representing an instruction to move through the playing background in a specified manner. This signal would have been determined by the controller in the manner described above and then transmitted to the markers in a manner to be described shortly. The circular shape with the cross inside it 92 means that the T(1) signal may optionally also include a signal on the ball 93 instructing the player to, for example, carry the ball using a particular feet between T(1) and T(2). According to our earlier definition, however, such a signal component is not a part of the specification of a random path. In an abstract sense it could be, but since it doesn't affect the geometry of the travelled path it is better to view it as a separate instruction, specifying a particular method of playing.

At only one of the time instances T(1), . . . , T(n) there may be an optional instruction, which as explained previously will be a part of the specification of the random path, given by the system to pass or shoot the ball 98 which automatically leads to the start of a new random path 104. The simulation may alternatively continue 101 to the final instruction at time instance T(n) after which either the session ends 100 or continues with a new random path 104. After the end of the playing session the system will ensure 105 that the random paths to be generated during the next playing session will be different.

Earlier it was stated that shooting instructions may exist continuously, not just at one time instance. This can easily be implemented in the same manner as for a method of playing signal. The only minor difficulty is identifying when the player would have taken the shot. This can be done by adding appropriate sensors on the ball or in and near the goal area to detect when the ball has been kicked and when this has been detected signal back to the controller to stop to signalling for the rest of the path. Alternatively, the system may continue signalling from time T(1) until T(n) irrespective of the player deciding to shoot early.

This approach is appropriate when signals propagate from one set of adjacent markers to another neighbouring set. It will also work without too much difficulty when transitions for the primary marker are allowed from one marker to any other marker in the playing background. This will require a transition probability matrix which specifies the probability of the primary marker transitioning from any one particular marker within the playing background to another. A separate distribution may also be specified for the time allowed to complete each possible transition; alternatively, these may be specified deterministically.

The path signals of FIG. 19 appear on the markers under the preferred embodiment. However, these signals can instead appear on a motional element.

In that case it would be best not to include other signals on the motional element to avoid confusions. Such an approach may reduce the cost of the apparatus by requiring minimal circuitry on the many markers, more than compensating the cost of additional circuitry on a single motional element. The approach will be particularly suitable for remote controlled toy car racing around a circuit as the player will automatically have their focus on the toy vehicle. In that case, as the vehicle approaches each marker a signal will appear on it to specify the side on which to pass the marker. This will require some form of detection (or RFID tagging etc.) between the vehicle and the marker. Details of how this can be made to work has been explained elsewhere to in this document.

Deterministic Case

The deterministic case is when the player knows the signals in advance, including the time intervals between successive signals. This may be when the apparatus allows the player to specify a particular set of signals or when it reveals to the player in advance what the signals will be or when the entire path is revealed at the initial time instance and it remains observable until the final time instance. In any of these cases, the system may in particular repeat the same set of signals to allow the player to practice completing the same course many times. The apparatus may also allow the player to raise the tempo of the simulations over the course of a playing session so as to increase the level of difficulty.

A version of the apparatus capable of generating paths in both random and deterministic fashions can be developed as well as versions capable of generating only one of these types of paths.

The two major features of the invention are time dynamics and path randomisation. The first tests a player's ability to complete the path in a set time and the second tests their ability to make decisions almost instantaneously. The increasing capabilities of the system can be described as follows:
1. At the simplest level, over a defined time period [0, T] the apparatus will generate a complete path, testing the player's ability to complete the course over a set time.
2. The next level of sophistication sees the path being defined in stages but still in a manner known to the player, with a signal at time 0=T(1) and so on until the final one at time T=T(n). This tests the player's ability to complete each segment of the path in the required time period.
3. Finally, each signal at times T(1), . . . , T(n) is random and not known in advance to the player, thus also testing their ability to make quick decisions.

An intermediate level is possible between 1 and 2 above (or between 2 and 3), where a sub-path is defined for a sub time period between [0, T]. Furthermore, a more basic level than 1 is possible, with a partially defined path over the duration [0, T], leaving the player free to move as they choose for the unspecified part of the path (e.g. for 1-dimensional embodiment with 10 markers, the signalling only specifies the correct side to pass 5 of the markers with the player free to choose the sides to pass the other 5 markers).

Transmission of Electrical Signals

The transmission of the electrical signals may be via wires or wirelessly. Using wires to transmit signals may in some cases require extra care to ensure they do not cause significant obstruction to the playing of the game. This can be done by using sufficiently thin wires or laying them beneath the playing surface. Where wired transmission without causing material obstruction to the playing of the game is possible it will be the preferred mode of signalling.

Because of the possibility of the player blocking a direct line of to communication between the controller and the other elements of the system and likelihood of relatively large distances between the controller and the rest of the apparatus, infrared wireless signalling may not be suitable for many applications. Therefore, radio frequency is the preferred wireless mode of signal transmission. However, infrared may be more appropriate for alternative embodiments of the system as discussed later. Moreover, infrared could be made to work more generally by indirectly relaying the signals, thereby potentially overcoming obstructions and distance problems.

By signal relaying it is meant, for example, that a signal from a first device to a third device, which cannot be transmitted directly, must first be sent to a second device which is then able to send it to the third one. If necessary, further intermediate devices can be added. For our system, a relay network consisting of additional devices around the edges of the playing background, and potentially inside it as well, could be used to ensure the signal is received by the desired parts of the apparatus.

Under the preferred embodiment, the markers must be arranged in the correct order for the signalling from the controller to work as expected. For a linear arrangement of ten markers, for example, the controller will assume one unique marker with its corresponding address to be located first, then another particular one second and so forth. If the actual marker arrangement is different, the path seen by the player will not be the one intended by the controller and in particular the timing allowed may not be consistent with the distance between the markers of successive signals.

Fulfilling this requirement is easily achieved by writing on each marker where it should be placed within a playing background. Observing this requirement may be made easier by appropriate colour coding on the markers and the separate storage of markers from different rows, for example. A control mechanism may also be included within the system to check that the order of the markers are correct, by including a functionality for the controller to send a signal to each marker in turn in a systematic manner.

Improvements to the system are, however, possible to entirely overcome the requirement to arrange the markers in a pre-specified manner. For instance, each marker may include a control or remote control button for communicating its address to the controller which will have the functionality to enable the user to specify the dimensions of the playing background, such as the number of rows and columns. These features will allow the user to communicate to the controller the address of the marker at each location within the playing background by systematically pressing the button of each marker starting with the marker on row one, column one, then the marker on row one, column two and so on until the marker on the final row and final column.

This approach is very manual but can easily be automated as follows:
1. User specifies to the controller the dimension of the playing background, such as the number of rows and columns.
2. User presses a button on the marker at row one, column one which then sends a signal to the controller confirming its address. It also emits a signal with direction and signal strength level such that the signal is only received by its neighbouring marker on the right.
3. The neighbouring marker on the right similarly sends a signal back to its neighbour on its left to confirm receipt of the latter's signal. It then signals its address to the controller before communicating with its neighbour on the right in the same manner as described above.
4. This continues until the final marker of the row is reached which however will not get a response from a neighbour to its right because it is the right most marker on that row. Realising this, it will emit a signal directed to its neighbour in front of it. This signal will tell the neighbour to communicate its address to the controller and then to communicate with its neighbouring marker on the left. A similar process as for the first row ensues which will inform the controller the addresses of the markers on the second row and this continues until the final marker within the array signals to the controller.

This approach generalises easily to one and three dimensions and can be made to work for triangular playing background arrangements too. It does, however, require marker spacings to be uniform across the playing background.

The controller being a part of the apparatus will allow it to have much greater user functionality, such as setting the tempo of the simulations and deciding whether or not there should be a method of playing component in the signalling. It being a part of the apparatus will also improve its efficiency by centralising difficult tasks such as drawing random numbers instead of these to being performed by individual parts of the system. Of course, the controller can also be used as a marker by giving it appropriate additional features, although this is not recommended because damaging it will prevent the whole system from being used (unlike with a marker which if it were to be damaged can be removed from the system by a setting change). A motional element can also be the controller and this choice can be quite appropriate for some applications (e.g. remote controlled toy car or a go-kart). Of course, when there is already a remote control device or similar this can be enhanced to also be the controller for the apparatus.

Common devices such as a mobile phone, laptop, etc. that are capable of sending signals can be used as the controller. In that case, such a device simply needs appropriate software to run the system.

The preferred embodiment of the apparatus includes the controller and, by default, the markers. A motional element may be part of it too but only for the purpose of communicating a method of playing signal. Finally, where appropriate a separate audio visual device may also be included to reinforce the observable signals on the markers.

It could in some cases be meaningful for signals to appear only on the separate audio visual device, particularly when the player is stationary during play, but that would not be the preferred embodiment. Note also that it would be possible to integrate audio visual features into the controller.

Under the preferred embodiment described above, the controller determines to the timing of the signals irrespective of the player performance. It will not wait for the motional element to reach the appropriate marker before signalling. It is part of the challenge of using the apparatus for the player to keep up with the signals.

One of the alternative embodiments listed below, based on detection between motional elements and markers, automatically ensures signalling coincides with the motional element being near the signalling markers. These two embodiments can be combined to achieve signalling by a controller at times when the motional elements are close to the desired markers, as follows:
1. For a given path, controller signals to the next marker that defines it.
2. When a motional element is detected at this marker, signal appears on it. The marker also communicates to the controller that it has signalled.
3. The controller then signals to the next marker on the path and the above continues until the path is fully defined.

### Alternative Embodiments

An alternative embodiment of the system is for the markers to communicate with other markers to determine the random path. They may also communicate with motional elements to provide additional instructions. A separate controller will not be required.

As a simple example, consider the one-dimensional embodiment such as that shown in FIG. 1. After the playing background has been set and markers turned on, the first marker draws a random number to determine its signal to indicator. It then sends a signal to the following marker for it to indicate a signal after a period of time encoded within the signal. This encoding of the time period will allow the system to vary the tempo of the simulation or even make this time period random.

The signalling continues until the end of the line is reached. The system may then after a suitable time interval propagate signals in the reverse direction and this may continue until it is turned off. Each marker will draw random numbers to determine the signal indicator; if only one marker did this then in effect it becomes a controller.

For this simple case, which does not include passing or shooting instructions or signals to the motional elements, the signal strength and direction can be set to only reach the following marker, thereby negating the need to define addresses for the markers and the need to arrange them in a pre-specified manner. By relaying a signal through the markers, this argument can be extended to signals from one marker to any other within the playing background. It can also be extended to any uniform arrangement of markers in any dimension, provided the markers are able to direct signals to ensure they are reached by only one of the adjacent markers. This signal directing can be achieved by the markers being able to transmit in the direction of each of the adjacent markers and on each signalling occasion only one direction being activated.

We note that although the above approach requires the markers to be uniformly spaced for the signalling to correctly propagate through the playing background, the actual indicated path can be non-uniform. That is, the distance to between the first and second points on the path can be different to the distance between the second and the third points, for example.

The concept of a marker address can be retained and be used in the signalling process, particularly in a sense local to each marker. Under such a local addressing approach, each marker will only know the address of its adjacent markers and will only be able to directly signal to one of them at any time instance. Signals from one marker can still reach any other within the playing background but will need to be relayed if the other marker is not an adjacent one. Of course, if each marker knew the address of all the other markers, which would be a global addressing system, then each one can send a direct signal to any other provided the mode of signalling is capable of doing so. The use of either local or global addressing will, however, require the markers to be arranged in a pre-specified manner.

Where appropriate the markers may also send signals to a ball or similar object for communicating a method of playing instruction, and create instructions for passing and shooting (of course even the path signals can be sent to a motional element to finally reveal the instruction to the player instead of this being done by markers).

This approach is easily extended to cases when signal indication is done using multiple adjacent markers. In the latter case the primary marker within the group of adjacent markers will have a special role.

A session will be initiated by the user specifying the initial primary marker to which will then draw a random number to determine the initial signal state. It will communicate this to the rest of the group and the group will together indicate the signal state. The initial primary marker will also communicate to the primary marker of the second time instance in the simulation, which was determined by the initial drawing of the random number. The new primary marker will do the same as the initial one and the process continues until the simulation ends.

Line of sight communication will be possible under this embodiment provided direct communication between only neighbouring markers is used. If necessary a slight delay may be introduced to the signal indication to ensure the electrical signal is always ahead of the motional elements. Radio frequency and even wired are other alternative signalling modes.

Another embodiment is via detection between the markers and a motional element. When the motional element is sufficiently close to a marker, detection will occur and will then trigger the displaying of a signal indicator on either the marker or on the motional element, determined by the drawing of a random number (within the same element as revealing the signal indicator, although the other element can alternatively do this and then transmit to the signalling element). Simulation of a random path is completed when the player moves from one endzone to another. This approach has the disadvantage that the random path is in part determined by the action of the player. For example, if the player continues travelling between the endzones, a random path can become indefinitely long. However, the approach retains the key feature of generating random instructions to train the player to make quick motional to decisions. Therefore, if a player wishes to concentrate solely on developing their decision making skill they may in fact deliberately ensure the random path continues indefinitely. Of course, the preferred embodiment can be configured to also include such a functionality.

An alternative embodiment of the system is for it to define discrete instances in time at each one of which only a single marker or a group of adjacent markers will be timed to reveal a predefined, but unknown in advance to the player, signal indicator; several such signal indicators will collectively define a random path and the system will generate many different paths during a playing session thereby giving the impression to the player of the paths being random.

To illustrate the simplicity of implementing this approach, consider the random path illustrated in FIG. 2. This path has nine signals, beginning with an “L” instruction at time T₁ and ending with “shoot” at time T₉.

At time T₁ all markers and goal cells will remain deactivated (state 0), except the marker with the initial “L” instruction which will be timed to come on (state 1) and reveal “L”. Note that even though only one marker is activated, all markers and goal cells must be programmed to evaluate a state at T₁. The same must be done for the other time instances up to T₉ when the random path is fully revealed.

To continue generating further random paths, subsequent time instances T₁₀, T₁₁, etc. along with corresponding signal state on every marker and goal cell for each such instance must be defined, including suitable rest periods between consecutive random paths. As before, it will be possible to vary the tempo of the simulations.

Yet another embodiment of the system is by using a positioning system to determine the locations of the markers and track the motion of the motional elements of the game; when the motional elements have reached a specified part of the playing background the system will instruct the player, by revealing observable signals on the markers or on a motional element or on a separate audio visual device, that the motional elements travel to another part of the playing background next and the system will determine this instruction by the drawing of random numbers; and in a similar manner the system will also be able to instruct at some instances in time the passing or the shooting of a motional element towards some specified markers, or send signals to a motional element to specify a particular method of playing.

Under some embodiments signals are revealed by a motional element without any electrical interaction with the markers. In such cases the markers can be non-electrical (i.e. not part of the apparatus). The determination and transmission of the signals can originate from a separate controller or from an onboard one. Either way, there will need to be an user interface to configure the simulations, such as time dynamics and whether the signals are deterministic or random. Such embodiments can be appropriate for vehicular pursuits in particular.

The alternative embodiments can also reveal signals in a deterministic manner.

Finally, it is very easy and natural to create video game versions of some of the various embodiments of the invention, requiring the video game player to control the movement of a virtual motional element within the video game so that it follows a specified path.

A Different Method for Electronic Markers

A player's skill can be developed and tested using an arrangement of electronic markers in a different way to those described previously. This new method defines a special status for markers, with the ones possessing this status being referred to as the interception markers. This special status, which will be observable to the player (e.g. special light being turned on), will initially be assigned to one or more markers at the start of play but will subsequently be transferred to other markers during play in a manner described below.

Referring, for example, to FIG. 2, the player will start from the side 22 and will attempt to reach the other end (side with the goal in the figure), the final row for this particular arrangement. One marker on that final row will, for this simple example, initially be assigned to be the interception marker.

The player is required to reach the other side of the arrangement without getting to within a defined range of the interception marker, which will constitute being intercepted (i.e. interception will have occurred). This range can for example be defined as the line segments between the interception marker and its two neighbouring markers on the same row.

As the player starts to move through the playing background, the interception marker status will, depending on the player's actual movement, be transferred so as to optimally defend the endzone from being reached by the player. This transferring of the interception status provides a quality of animation to the electronic marker system and makes it more closely resemble playing against real opponents.

There are two levels of system animation (i.e. status transfer):
1. Interception status transfer is restricted to markers on same row. This may be called the ‘passive defending’ approach.
2. Status can be transferred to any markers (‘aggressive defending’).

In either case, the status transfer will take an appropriate length of time to retain realism of playing against actual defenders. Transfer from one end of a row to the other, for example, can be staggered marker to neighbouring marker until reaching the desired destination, or, more awkwardly for the user, it can be direct but with a realistic time lag. The time taken to transfer status is a key parameter that is user configurable. The player may start with a long transfer time configuration then progress to shorter times as they improve their skill level.

When the player enters the marker collection, the system will identify their location (row and column indices) and this information will be communicated to the markers holding the interception status. As they keep moving, the system will keep capturing their location and continually communicate this information to the interception markers, triggering successive interception marker transfers as follows:
1. After receiving a new location signal and before the next such signal, intercept status will be transferred to first match the column index of the player then match the row index (or visa versa). This is for the ‘aggressive defending’ mode; for the ‘passive defending’ mode only column matching will occur.
   a. Column matching means if interception marker is at column 4 and receives information player is at column 3 (on a different row), transfer of interception status will be made to marker on column 3 of the same row, etc.

In the above approach, column matching takes precedence over row matching by default to minimise computations and delay. An optimisation can be introduced so preference is given to one (row or column) which has the biggest (or smallest) discrepancy with the player's location. Also, when a new locational signal has been received before the last one has been processed, the signal can either be processed immediately (i.e. processing of last signal is cancelled) or after completion of the processing of the last signal.

Also in the above approach, transfer is to a neighbouring, non-diagonal marker, because each move changes only the row or column index but not both as would be the case with a move to a diagonal neighbour. The possibility of a diagonal transfer can be introduced and can be executed when there is both row and column discrepancy between the locations of the interception marker and the player, but will require additional computations. It would make sense for diagonal transfers to be made first, followed by one of row-wise or column-wise transfers until reaching the player's location.

If the player passes the last row of markers without being intercepted at any time during the play then they would have succeeded; otherwise not. In fact, for a system capable of aggressive defending, the player may simply be asked to avoid being intercepted without also being required to reach a particular destination. To do so, they will have to continually update their path in response to transfers of the interception markers. It would be possible to have many interception markers and for them to start on rows other than the final one.

There are multiple ways to monitor the player's location within the collection of electronic markers. One would be to add sensors to capture the player passing the right side, for example, of a marker. As soon as this occurs the marker will emit a strong enough signal to communicate its location to an interception marker anywhere within the playing background.

Another way to track the player's motion would be to add short-range transmitters on a motional element and receivers onto the markers (note the approach will also work with the roles reversed). Actually, only some markers need to have receiving capability to sufficiently track the motion of a motional element, for example markers with odd numbered row and column indices and markers with even numbered row and column indices.

Assuming the markers are uniformly spaced and the read range of the receivers is equal to this distance, the transmit signal from the motional element will be received by at least one and at most two markers (which will be diagonally across). Such a marker will then emit a strong enough signal to communicate its location to the interception marker.

To avoid potential problems with two markers simultaneously signalling their locations, markers on even numbered rows could transmit using a different frequency to ones on odd numbered rows. The interception marker can then transfer the status to another marker by optimisation or by default preference in a similar manner to above. Instead of using different frequencies, one may alternatively introduce a delay to transmission from, say, markers from even numbered rows.

The interception range can be defined to be a circle of radius equal to the distance between neighbouring, non-diagonal markers (i.e. inter marker distance). This definition will in particular require the player to avoid crossing the segments between the intercept marker and its two neighbours on the same row.

The most obvious way to track motion would, of course, be via a positioning system. For this particular application, as well as tracking the motion of the motional element, the positioning system can also control the transfer of the interception marker status; turning off the signal on the current interception marker and on the next one using the logic described previously.

Interception markers can come in pairs or higher number of adjacent markers. Interception can naturally then be defined as having occurred if the motional element cuts across or enters the region so defined. Transfer of interception markers is same as before, occurring uniformly for the group (i.e. everything going left etc); tracking of the player is the same as before.

The above method can be applied to various sports, vehicular pursuits, etc; anything which has at least one motional element, not necessarily the player (e.g. remote controlled car). In appropriate cases, goals and shooting instructions can be added in a similar manner to before (e.g. after passing the final row, signal to shoot into one particular cell is generated). Other strategies for transferring interception marker status can also be incorporated. The method can also be extended to height varying arrangements in either 2- or 3-dimensions.

1. An apparatus consisting of:
a. a playing background of a collection of electronic markers; or,
b. a playing background of a collection of electronic markers, and one or more motional elements which are also able to process electrical signals;
and a method consisting of several observable signals during a period of time, each representing an instruction to the player for the motion of the one or more motional elements of the game through the playing background in one of the following ways or some combination thereof:
c. Passing a marker on a particular side, with a distinct observable signal for each possible side to pass a marker by or a subset thereof containing at least two members; or,
d. Moving in the direction from near the current marker to a neighbouring one, with a distinct observable signal for each possible direction or a subset thereof containing at least two members; or,
e. Moving through the line segment or region defined by a group of adjacent markers; or,
f. In the case where the height level of the markers vary, moving from one part of the playing background to another; or,
g. In the case of a playing background consisting of several, separate lines each split into smaller segments, travelling over a particular segment; or,
h. In the case of a playing background consisting of a surface that is fully covered by a collection of non-overlapping markers, moving from one marker to another;
wherein the observable signals will appear on either one or both of the following:
i. one or more of the markers; or,
j. one or more of the motional elements;
and all signals will be generated automatically by:
k. one or more of the markers; or,
l. by one or more of the motional elements; or,
m. by one or more separate devices; or,
n. by some combination thereof;
and such signals will collectively define an observable path through the playing background.

2. Apparatus according to claim 1 which will also include one or more goals, each split into one or more regions and for which the method will also include one or more observable signals during the period of time representing instructions to shoot a motional element into a specified part of a goal

3-8. (canceled)
